(19) United States
(12) Patent Application Publication
(10) Pub. No.: US 2026/0163278 A1
(43) Pub. Date: Jun. 11, 2026

(54) SOCKET OF A PLUG-AND-SOCKET CONNECTION

(71) Applicant: Huber + Suhner BKtel GmbH, Hückelhoven (DE)

(72) Inventor: Robert JANßEN, Kevelaer (DE)

(73) Assignee: Huber + Suhner BKtel GmbH, Hückelhoven (DE)

(21) Appl. No.: 18/710,256

(22) PCT Filed: Sep. 27, 2022
(86) PCT No.: PCT/DE2022/100715

§ 371 Date: May 15, 2024

(30) Foreign Application Priority Data
Jan. 26, 2022 (DE) 10 2022 101 738.9

(51) Int. Cl. H01R 13/11; H01R 12/72; H01R 13/62

(52) U.S. Cl. CPC H01R 13/11; H01R 12/72; H01R 13/62

(57) ABSTRACT

The present invention relates to a socket of a plug-and-socket-connection into which socket a connector plug can be inserted in a direction of insertion, the socket being connected to at least one cooling element and having a cavity delimited by an opening and lateral walls and in which the connector plug rests when the plug-and-socket-connection is mounted. In order to devise a socket of a plug-and-socket-connection that has a simple design, can be cost-effectively mounted and allows for reliable and sufficient heat dissipation, according to the invention, the cooling element receives a wedge clamp that produces contact with the connector plug when the plug-and-socket-connection is mounted.

The present invention relates to a socket of a plug-and-socket-connection into which socket a connector plug can be inserted along a direction of insertion, the socket being connected to at least one cooling element and having a cavity delimited by an opening and lateral walls and in which the connector plug rests when the plug-and-socket-connection is mounted.

Such sockets are known from prior art for various purposes and allow effective wired transmission of electrical and/or optical signals, particularly in the context of network connections. In modern network connections, the performance and thus the data transmission of such plug-and-socket-connections is constantly increasing, which also increases the requirements for effective heat dissipation in order to ensure interference-free data transmission and thus a stable network connection.

From US 2020/0301076A1 , for example, a plug-and-socket-connection with a generic socket is known, which is configured there as an SFP cage (small form-factor pluggable cage) for receiving an SFP module (small form-factor pluggable module). SFP is a specification of a generation of modular optical or electrical transceivers. These devices are known as connector plugs for fast Ethernet, Fiber Channel or SONET. In order to dissipate the heat generated during data exchange, US 2020/0301076 A1 proposes leaf springs and flexible thermally conductive pads which are intended to create a flat contact between the connector plug and a cooling element. However, the plug-and-socket-connection described has a complex structure with the leaf springs and the flexible thermally conductive pads, which leads to high mounting costs. Furthermore, due to the design, the possible heat dissipation is not sufficient to provide adequate heat dissipation for modern network connections, which is why this plug-and-socket-connection has proven to be in need of improvement in practice.

DE 10 2017 204 939 A1 discloses an electrical connector comprising a housing, an electrical contact element received in the housing and a thermal bridge which has a heat receiving surface thermally connected to the electrical contact element and a heat transfer surface accessible outside the connector and electrically insulated from the contact element. Preferably, the electrical connector has a contact pressure element which, in an assembled state, generates a contact pressure between the electrical contact element, the thermal bridge and/or the housing.

U.S. Pat. No. 4,971,570 discloses a wedge clamp that is configured to be thermally conductive and clamps a circuit board within a heat sink.

Based in particular on US 2020/0301076A1 , it is the task of the present invention to eliminate the disadvantages of the prior art. In particular, a socket of a plug-and-socket-connection is to be devised which has a simple design, can be cost-effectively mounted and allows for reliable and sufficient heat dissipation.

This task is solved by the socket according to claim 1. According to the invention, it is provided that the cooling element receives a wedge clamp which produces a contact with the connector plug when the plug-and-socket-connection is mounted. Such a wedge clamp has one or more clamping jaws and clamps the connector plug within the socket when it is mounted, thereby forming a direct and large-area contact between the connector plug and the cooling element. This results in a thermal transition so that the heat generated at the connector plug is effectively dissipated passively and without additional active cooling. In addition, the wedge clamp provides additional fixation of the connector plug within the socket, resulting further in a vibration-resistant contact between the socket and the connector plug.

Advantageous further embodiments of the present invention are given below and in the subclaims.

In the context of a first advantageous embodiment of the invention, it is provided that the wedge clamp has a sliding wedge and a pressing wedge, which abut against each other on correspondingly formed wedge surfaces. The wedge clamp thus has two clamping jaws, wherein one clamping jaw is formed as a sliding wedge and one clamping jaw is formed as a pressing wedge. The sliding wedge preferably has a sliding surface opposite the wedge surface, which is formed at least in sections as a contact surface to the cooling element. In a comparable manner, it is preferably provided that the pressing wedge has a contact surface opposite the wedge surface, which is formed at least in sections as a contact surface to the connector plug. In the mounted state, it is preferably provided that the sliding surface of the sliding wedge is aligned parallel to the contact surface of the pressing wedge. Relative to the parallel contact surfaces, the correspondingly formed wedge surfaces of the sliding wedge and the pressing wedge in particular have an angle of 3° to 7°, preferably 5°.

According to a particularly preferred embodiment of the invention, it is provided that the wedge clamp rests within a recess of the cooling element, wherein the sliding wedge is mounted parallel to the direction of insertion and the pressing wedge is mounted orthogonal to the direction of insertion, so as to be slidable within the recess of the cooling element, so that the wedge clamp can be brought from a position clamping the connector plug into a position releasing the connector plug by a sliding movement of the sliding wedge. In other words, the sliding wedge can be moved within the recess of the cooling element, wherein the direction of movement is parallel to the direction of insertion of the connector plug. Due to the contact of the pressing wedge on the sliding wedge via correspondingly formed wedge surfaces, a displacement of the sliding wedge causes a displacement of the pressing wedge orthogonal to this, wherein the direction of movement of the pressing wedge is also aligned orthogonal to the direction of insertion and therefore orthogonal to the contact surfaces of the sliding wedge and the pressing wedge. By displacing the sliding wedge, the connector plug can thus be clamped within the socket, resulting in a large-area contact that forms a thermal transition for passive heat dissipation.

To ensure that, in the dismounted state of the plug-and-socket-connection, i.e. when the connector plug has been removed from the socket, the pressing wedge does not fall out of the recess of the cooling element, in the context of an advantageous further development of the invention, it is provided that the contact surface of the pressing wedge abuts at least in sections against a lateral wall of the cavity, so that the pressing wedge is arranged within the recess of the cooling element so that it cannot be lost.

To move the sliding wedge, an actuator is preferably provided which engages through the cooling element and is connected to the sliding wedge. Preferably, the actuator is configured as a bolt that engages through a bore in the cooling element, which extends from one end face to the recess in which the wedge clamp is received. Preferably, the actuator is spring-loaded by a spring, in particular a compression spring, and the wedge clamp can be moved against the force of the spring from the position clamping the connector plug into the position releasing the connector plug. To produce a plug-and-socket-connection, the actuator must therefore first be actuated against the force of the spring so that the wedge clamp assumes a position that releases and allows for the plug connector to be inserted along the direction of insertion. As soon as the connector plug is fully inserted into the cavity of the socket, the actuator is released so that the wedge clamp is brought into the position that clamps the connector plug by the force of the spring as the sliding wedge displaces the pressing wedge orthogonally to the direction of insertion and presses its contact surface onto the connector plug. This results in the thermal transition and the heat generated at the connector plug can be effectively dissipated.

In the context of an advantageous further development of the invention, it is provided that the socket is mounted on a circuit board which carries an interface for data transmission.

It is also preferably provided that the cooling element and the wedge clamp are made of a heat-conducting material, in particular aluminum, which increases the efficiency of the heat transfer.

Preferably, the socket is formed as an SFP cage (small form-factor pluggable cage) and the connector plug as an SFP module (small form-factor pluggable module).

Specific embodiments of the present invention are explained below with reference to the figures.

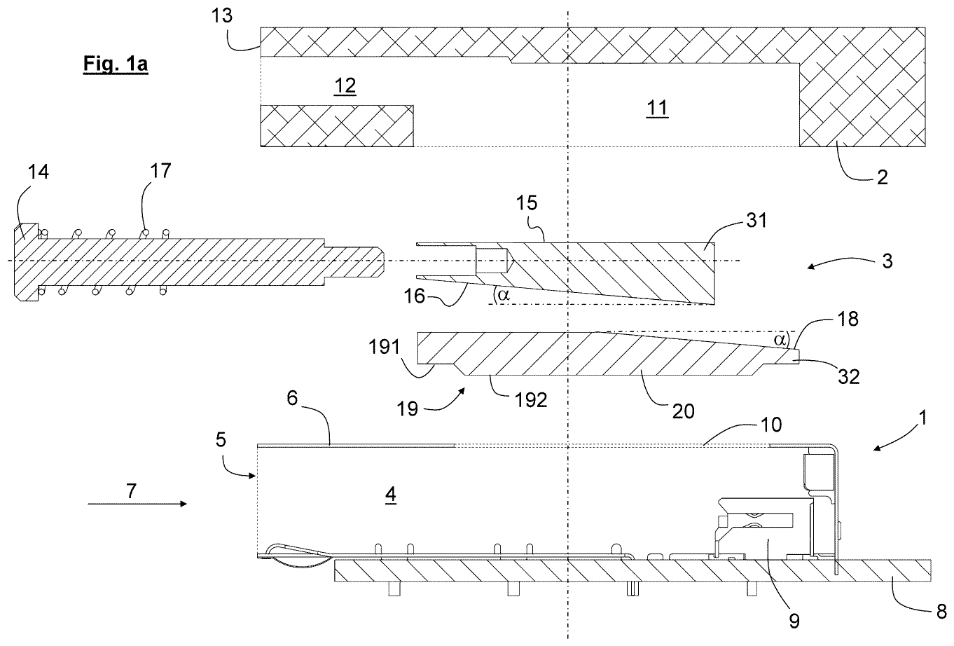

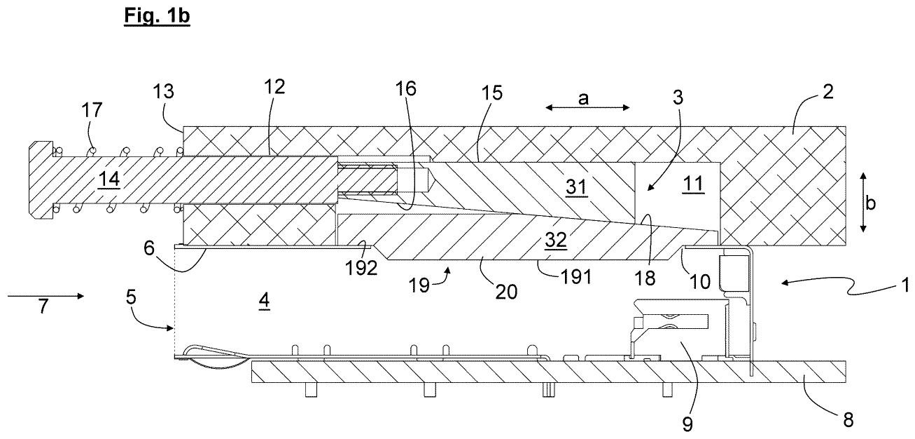

FIG. 1a shows an exploded view of a socket with a cooling element and a wedge clamp,

FIG. 1b shows a first cross-sectional view of a socket with a cooling element and a wedge clamp,

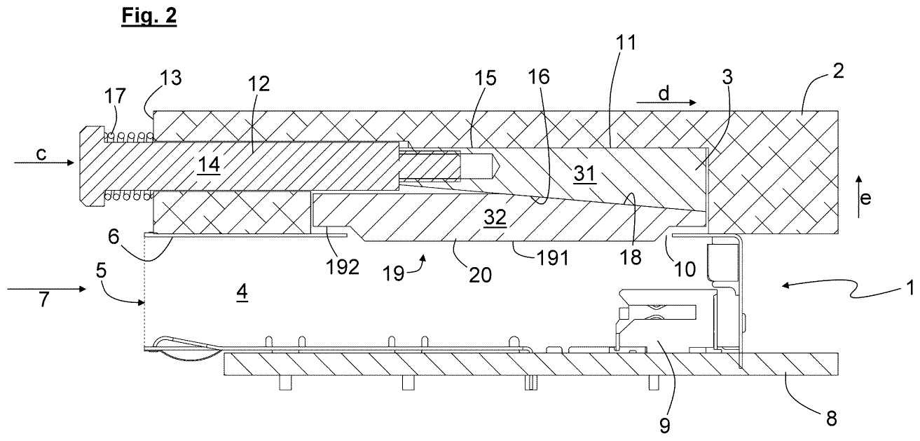

FIG. 2 shows a second cross-sectional view of a socket with a cooling element and a wedge clamp,

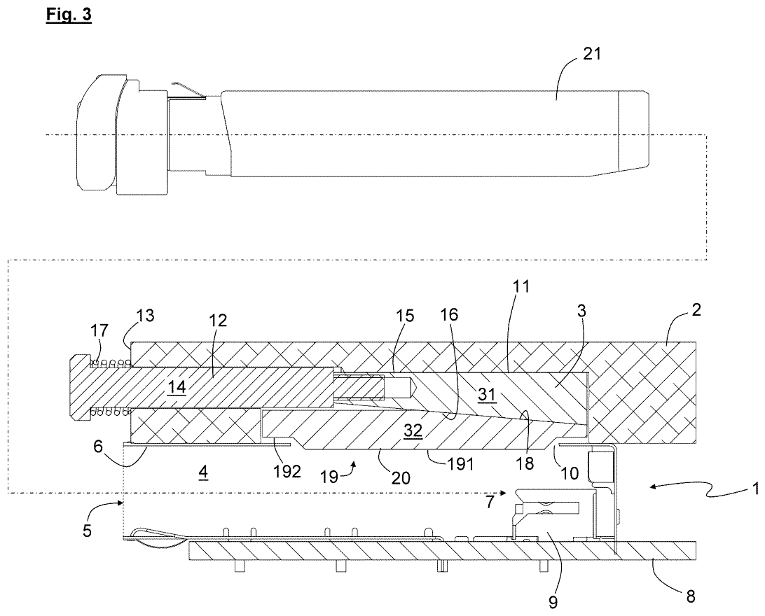

FIG. 3 shows an exploded view of a plug-and-socket-connection with a connector plug and a socket with a cooling element and a wedge clamp,

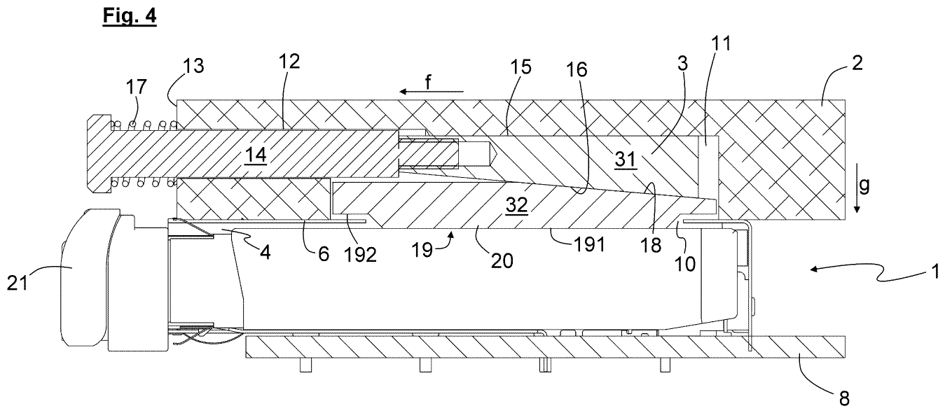

FIG. 4 shows a mounted plug-and-socket-connection with a connector plug, a socket, a cooling element and a wedge clamp and

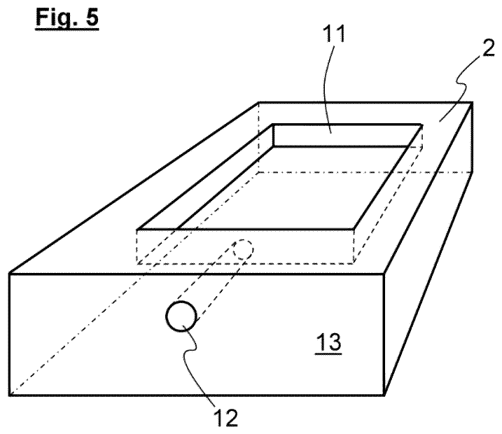

FIG. 5 shows a perspective view of a cooling element.

A specific embodiment of the invention is shown in FIGS. 1a,b, wherein FIG. 1a shows an exploded view of a socket 1 with a cooling element 2 and a wedge clamp 3 and FIG. 1b shows the mounted state.

The socket 1 has a cavity 4 delimited by an opening 5 and lateral walls 6, wherein the opening 5 is configured for the insertion of a connector plug not shown in FIGS. 1a,b in the direction of insertion 7. The socket 1 is mounted on a circuit board 8, which carries an interface 9 for data transmission. A recess 10 is formed on the lateral wall 6, which is opposite the circuit board 8. The socket 1 is at least indirectly connected to the cooling element 2, which in the example shown is made of thermally conductive aluminum and has a recess 11 that faces the socket 1 and is configured to receive the wedge clamp 3. Furthermore, the cooling element 2 has a bore 12 that extends through the cooling element 2 from the end face 13 to the recess 11. The wedge clamp 3 has two clamping jaws, one of which is formed as a sliding wedge 31 and one as a pressing wedge 32. The sliding wedge 31 is connected to an actuator 14, which engages through the bore 12 of the cooling element 2 in the mounted state. The sliding wedge 31 also has a sliding surface 15, which is formed as a contact surface for the cooling element 2. On the side opposite the sliding surface 15 of the sliding wedge 31, a wedge surface 16 of the sliding wedge 31 is formed, which is inclined by a wedge angle α of 5° relative to the sliding surface. The sliding wedge 31 can be displaced in the arrow direction a within the recess 11 of the cooling element 2 by actuating the actuator 14, wherein the actuator 14 is spring-loaded by a compression spring 17, which is positively mounted between the end face 13 of the cooling element 2 and the free end of the actuator 14.

The pressing wedge 32 has a wedge surface 18 which is formed corresponding to the wedge surface 16 of the sliding wedge 31 and therefore has a corresponding wedge angle α of 5° in relation to the sliding surface 15 of the sliding wedge 31. On the side of the pressing wedge 32 opposite the wedge surface 18, a contact surface 19 is formed, which forms two sections 191, 192. A first section 191 of the contact surface 19 is formed on a plateau-like projection 20, which engages through the recess 10 of the lateral wall 6 of the cavity 4. This first section 191 of the contact surface 19 is configured for contact with a connector plug not shown in FIGS. 1a, b. The second section 192 of the contact surface 19 surrounds the plateau-like projection 20 and thus the first section 191 of the contact surface 19 at least in sections and is configured as a contact surface for the lateral wall 6 of the socket 1. As a result, the wedge clamp 3 with its sliding wedge 31 and its pressing wedge 32 is securely mounted within the recess 11 of the cooling element 2 in the mounted state. The sliding wedge 31 and the pressing wedge 32 abut against each other on their corresponding wedge surfaces 16, 18. Within the recess 11 of the cooling element 2, the pressing wedge 32 can be displaced in the arrow direction b and thus orthogonally to the direction of insertion 7. A displacement parallel to the direction of insertion 7 is blocked by the lateral surfaces of the recess 11 of the cooling element 2.

FIG. 1b shows a state in which the compression spring 17 is relaxed. In this state, the pressing wedge 32 is held by the sliding wedge 31 in such a way that the second section 192 of the contact surface 19 abuts against the lateral wall 6 of the cavity 4 and the plateau-like projection 20 engages with the first section 191 of the contact surface 19 through the recess 10 of the lateral wall 6 of the cavity 4.

In order to insert a connector plug into the socket 1, the actuator 14 as shown in FIG. 2 is moved against the force of the compression spring 17 in the arrow direction c, so that the sliding body 31 is moved within the recess 11 of the cooling element 2 in the arrow direction d. This releases the sliding wedge 31 from the clamping contact to the pressing wedge 32 and the pressing wedge 32 can be displaced within the recess 11 of the cooling element 2 in the arrow direction e and thus orthogonally to the contact surface 19. In this position, the connector plug 21 according to FIG. 3 can be inserted into the cavity 4 of the socket 1 in the direction of insertion 7 until the position shown in FIG. 4 is reached, in which the connector plug 21 is fully inserted into the cavity 4 and the connection for data transmission is established. If the actuator 14 is released in this position, the sliding wedge 31 is displaced in the arrow direction f by the force of the compression spring 17 and thus presses the pressing wedge 32 onto the connector plug 21 in the arrow direction g, so that large-area contacts are formed between the connector plug and the pressing wedge, the pressing wedge and the sliding wedge and the sliding wedge and the cooling element, which allows effective and passive heat dissipation.

To remove the connector plug 21 from the socket 1, it has to be proceeded in reverse order. To do this, starting from the state according to FIG. 4, the actuator 14 is to be moved against the force of the compression spring 17 so that the wedge clamp 3 is brought into a position that releases the connector plug 21, which can thus be pulled out of the socket 1 against the direction of insertion 7. After the subsequent release of the actuator 14, the compression spring 17 relaxes, so that the state according to FIG. 1b is restored. Making and breaking the connection is therefore easily reversible.

FIG. 5 shows a perspective view of the cooling element 2, which is essentially rectangular in shape and has the essentially rectangular recess 11, which is configured to receive the wedge clamp not shown in FIG. 5. The bore 12, which is configured to receive the actuator not shown in FIG. 5, extends from the end face 13 to the recess 11.

### LIST OF REFERENCE SYMBOLS

1 Socket
2 Cooling element
3 Wedge clamp
31 Sliding wedge
32 Pressing wedge
4 Cavity
5 Opening
6 Side panel
7 Direction of insertion
8 Circuit board
9 Interface
10 Recess (at the lateral wall)
11 Recess (in the cooling element)
12 Bore
13 Front side
14 Actuator
15 Sliding surface
16 Wedge surface (of the sliding wedge)
17 Pressure spring
18 Wedge surface (of the pressing wedge)
19 Contact surface (of the pressing wedge)
191 First section (of the contact surface of the pressing wedge)
192 Second section (of the contact surface of the pressing wedge)
20 Projection
21 Connector plug
A Wedge angle
a-g Arrow directions

1. Socket of a plug-and-socket-connection, into which socket a connector plug can be inserted in a direction of insertion, the socket being connected to at least one cooling element and having a cavity-delimited by an opening and lateral walls and in which the connector plug rests when the plug-and-socket-connection is mounted,
wherein
the cooling element receives a wedge clamp that produces contact with the connector plug when the plug-and-socket-connection is mounted.

2. Socket according to claim 1, wherein the wedge clamp has a sliding wedge and a pressing wedge, which abut against each other on correspondingly formed wedge surfaces.

3. Socket according to claim 2, wherein the sliding wedge has a sliding surface opposite the wedge surface, which is formed at least in sections as a contact surface to the cooling element.

4. Socket according to claim 2, wherein the pressing wedge has a contact surface opposite the wedge surface, which is formed at least in sections as a contact surface for the connector plug

5. Socket according to claim 2, wherein the wedge clamp rests within a recess of the cooling element, wherein the sliding wedge is mounted parallel to the direction of insertion and the pressing wedge is mounted orthogonally to the direction of insertion so as to be slidable within the recess of the cooling element, so that the wedge clamp can be brought from a position clamping the connector plug into a position releasing the connector plug by a sliding movement of the sliding wedge.

6. Socket according to claim 4, wherein the contact surface of the pressing wedge abuts at least in sections against a lateral wall of the cavity, so that the pressing wedge is arranged inside the recess of the cooling element in such a way that it cannot be lost.

7. Socket according to claim 5, wherein an actuator is provided for displacing the sliding wedge, which actuator engages through the cooling element and is connected to the sliding wedge.

8. Socket according to claim 7, wherein the actuator is spring-loaded by a spring, in particular a compression spring, and the wedge clamp can be moved against the force of the spring from the position clamping the connector plug into the position releasing the connector plug.

9. Socket according to claim 1, wherein the socket is mounted on a circuit board which carries an interface for data transmission.

10. Socket according to claim 1, wherein the cooling element and the wedge clamp are made of a thermally conductive material, in particular aluminum.
